(19) United States
(12) Patent Application Publication
(10) Pub. No.: US 2012/0140068 A1
(43) Pub. Date: Jun. 7, 2012

(54) Medical Situational Awareness System

(75) Inventors: David A. Monroe, San Antonio, TX (US); Jeffrey D. Browning, Boerne, TX (US)

(73) Assignee: E-Watch, Inc., San Antonio, TX (US)

(21) Appl. No.: 13/152,432

(22) Filed: Jun. 3, 2011

Related U.S. Application Data
(63) Continuation of application No. 11/123,791, filed on May 6, 2005, now abandoned.

(51) Int. Cl. H04N 7/18

(52) U.S. Cl. 348/143; 348/E07.085

(57) ABSTRACT

The visual condition of a patient is monitored by defining a an authorized patient zone, placing a video camera in a location to capture a visual image of the patient zone, defining a base visual image of the patient zone, monitoring the visual image at a remote location, identifying any change in the captured image from the base visual image, and generating an alert in the event a change is detected. Certain changes in the zone may occur without generating an alert. Authorized personnel may enter and leave the zone without generating an alert. In a typical application the system for practicing the method is networked based for providing medical appliance data directly to key personnel at a standard computer station. The system also includes video monitoring in real-time or near real-time, providing visual as well as technical monitoring of the patient wherever he is located. In one aspect of the invention, the system is IP based, permitting access to the information anywhere on the World Wide Web.

### CROSS REFERENCE TO RELATED APPLICATIONS

The present invention is a Continuation-In-Part of and claims priority from pending patent application Ser. No. 09/594,041, filed on Jun. 14, 2000, titled MULTIMEDIA SURVEILLANCE AND MONITORING SYSTEM INCLUDING NETWORK CONFIGURATION, the contents of each of which are enclosed by reference herein.

The present invention is further related to patent application patent application Ser. No. 09/593,901, filed on Jun. 14, 2000, titled DUAL MODE CAMERA, patent application Ser. No. 09/593,361, filed on Jun. 14, 2000, titled DIGITAL SECURITY MULTIMEDIA SENSOR, patent application Ser. No. 09/716,141, filed on Nov. 17, 2000, titled METHOD AND APPARATUS FOR DISTRIBUTING DIGITIZED STREAMING VIDEO OVER A NETWORK, patent application Ser. No. 09/854,033, filed on May 11, 2001, titled PORTABLE, WIRELESS MONITORING AND CONTROL STATION FOR USE IN CONNECTION WITH A MULTI-MEDIA SURVEILLANCE SYSTEM HAVING ENHANCED NOTIFICATION FUNCTIONS, patent application Ser. No. 09/853,274 filed on May 11, 2001, titled METHOD AND APPARATUS FOR COLLECTING, SENDING, ARCHIVING AND RETRIEVING MOTION VIDEO AND STILL IMAGES AND NOTIFICATION OF DETECTED EVENTS, patent application Ser. No. 09/960,126 filed on Sep. 21, 2001, titled METHOD AND APPARATUS FOR INTERCONNECTIVITY BETWEEN LEGACY SECURITY SYSTEMS AND NETWORKED MULTIMEDIA SECURITY SURVEILLANCE SYSTEM, patent application Ser. No. 09/966,130 filed on Sep. 21, 2001, titled MULTIMEDIA NETWORK APPLIANCES FOR SECURITY AND SURVEILLANCE APPLICATIONS, patent application Ser. No. 09/974,337 filed on Oct. 10, 2001, titled NETWORKED PERSONAL SECURITY SYSTEM, patent application Ser. No. 10/134,413 filed on Apr. 29, 2002, titled METHOD FOR ACCESSING AND CONTROLLING A REMOTE CAMERA IN A NETWORKED SYSTEM WITH A MULTIPLE USER SUPPORT CAPABILITY AND INTEGRATION TO OTHER SENSOR SYSTEMS, patent application Ser. No. 10/163,679 filed on Jun. 5, 2002, titled EMERGENCY TELEPHONE WITH INTEGRATED SURVEILLANCE SYSTEM CONNECTIVITY, patent application Ser. No. 10/719,792 filed on Nov. 21, 2003, titled METHOD FOR INCORPORATING FACIAL RECOGNITION TECHNOLOGY IN A MULTIMEDIA SURVEILLANCE SYSTEM RECOGNITION APPLICATION, patent application Ser. No. 10/753,658 filed on Jan. 8, 2004, titled MULTIMEDIA COLLECTION DEVICE FOR A HOST WITH SINGLE AVAILABLE INPUT PORT, patent application No. 60/624,598 filed on Nov. 3, 2004, titled COVERT NETWORKED SECURITY CAMERA, patent application Ser. No. 09/143,232 filed on Aug. 28, 1998, titled MULTIFUNCTIONAL REMOTE CONTROL SYSTEM FOR AUDIO AND VIDEO RECORDING, CAPTURE, TRANSMISSION, AND PLAYBACK OF FULL MOTION AND STILL IMAGES, patent application Ser. No. 09/687,713 filed on Oct. 13, 2000, titled APPARATUS AND METHOD OF COLLECTING AND DISTRIBUTING EVENT DATA TO STRATEGIC SECURITY PERSONNEL AND RESPONSE VEHICLES, patent application Ser. No. 10/295,494 filed on Nov. 15, 2002, titled APPARATUS AND METHOD OF COLLECTING AND DISTRIBUTING EVENT DATA TO STRATEGIC SECURITY PERSONNEL AND RESPONSE VEHICLES, patent application Ser. No. 10/192,870 filed on Jul. 10, 2002, titled COMPREHENSIVE MULTI-MEDIA SURVEILLANCE AND RESPONSE SYSTEM FOR AIRCRAFT, OPERATIONS CENTERS, AIRPORTS AND OTHER COMMERCIAL TRANSPORTS, CENTERS, AND TERMINALS, patent application Ser. No. 10/719,796 filed on Nov. 21, 2003, titled RECORD AND PLAYBACK SYSTEM FOR AIRCRAFT, patent application Ser. No. 10/336,470 filed on Jan. 3, 2003, titled APPARATUS FOR CAPTURING, CONVERTING AND TRANSMITTING A VISUAL IMAGE SIGNAL VIA A DIGITAL TRANSMISSION SYSTEM, patent application Ser. No. 10/326,503 filed on Dec. 20, 2002, titled METHOD AND APPARATUS FOR IMAGE CAPTURE, COMPRESSION AND TRANSMISSION OF A VISUAL IMAGE OVER TELEPHONIC OR RADIO TRANSMISSION SYSTEM, patent application Ser. No. 11/057,645 filed on Feb. 14, 2005, titled MULTIFUNCTIONAL REMOTE CONTROL SYSTEM FOR AUDIO AND VIDEO RECORDING, CAPTURE, TRANSMISSION AND PLAYBACK OF FULL MOTION AND STILL IMAGES, patent application Ser. No. 11/057,814, filed on Feb. 14, 2005, titled DIGITAL SECURITY MULTIMEDIA SENSOR, and patent application Ser. No. 11/057,264, filed on Feb. 14, 2005, titled NETWORKED PERSONAL SECURITY SYSTEM, the contents of each of which are enclosed by reference herein.

### BACKGROUND OF THE INVENTION

1. Field of the Invention

The invention relates generally to network based security, surveillance and monitoring systems and is specifically directed to a networked surveillance system to monitor patients' movements in a health-care environment.

2. Discussion of the Prior Art

Patients spend much of their time convalescing in bed, or perhaps in machinery required for various procedures. During those times, they may deviate from the desired location. For example, a patient may get out of bed when they are not supposed to move. Or they may attempt to get out of bed without assistance when the doctor has ordered that they must have assistance when out of bed. Or they may inadvertently roll out of bed. Video surveillance can assist in these and other similar cases.

Network based security and surveillance systems are now well known and are described in detail in the copending applications listed above and incorporated by reference herein. One area where such systems would be useful but have not been employed is in the monitoring of patients either in an at-home environment or in medical facilities. Typically, state of the art systems provide networked alarms to a central nurse or administration station for alerting personnel when monitoring apparatus such as an EKG machine or the like indicates a patient is in distress. However, visible checking of the patient's condition can only be accomplished by actual visual checking of the patient where he is physically located. This requires personnel time while making rounds and also removes the personnel from the central station where other patients are being monitored. Thus, typically one staff member must always be present at the station or monitoring will have gap periods when the station is unmanned.

In addition, there is not any system that permits the patient's information to be sent to other locations such as, by way of example, the location of the attending physician. The only way this information is typically sent to such personnel is by on-sight personnel at the station relaying the information by telephone or e-mail. It would be useful for the physician to have access to the actual data rather than pass through information from on-site personnel. Patient privacy is an important consideration. There is not any system that selectively permits the patients information, particularly video streams and/or medical telemetry streams of the patient, to be selectively sent only to medical personnel and/or family members who are authorized to receive such information or data feed.

In another situation, where the patient is in home care, there is not any method for providing all of this information to a central monitoring and processing station. It would be useful to be able to monitor a patient wherever he or she is located.

### SUMMARY OF THE INVENTION

The visual condition of a patient is monitored by defining an authorized patient zone, placing a video camera in a location to capture a visual image of the patient in the zone, defining a base visual image of the patient zone, monitoring the visual image at a remote location, identifying any change in the captured image from the base visual image, and generating an alert in the event a change or specified condition is detected. Certain changes in the zone may occur without generating an alert. For example, in an preferred embodiment authorized personnel may enter and leave the zone without generating an alert.

In one embodiment of the present invention, a method for monitoring the visual condition of a patient comprises defining a base visual image of the patient zone, capturing a visual image of the patient zone, identifying any change in the captured visual image from the base visual image, and defining a sub-zone within the patient zone, wherein the sub-zone is defined by at least one of: a color on a patient's clothing, a pattern on the patient's clothing, and a facial recognition of the patient.

In another embodiment of the present invention, a method for monitoring the visual condition of a patient comprises defining a base visual image of the patient zone, capturing a visual image of the patient zone, identifying any change in the captured visual image from the base visual image, and permitting certain changes to occur in the captured visual image without generating an alert, wherein the changes include a presence of certain personnel other than a patient.

The subject invention provides a networked based system for providing medical appliance data directly to key personnel at a standard computer station. The system also includes video monitoring in real-time or near real-time, providing visual as well as technical monitoring of the patient wherever he is located. In one aspect of the invention, the system is IP based, permitting access to the information anywhere on the World Wide Web. Further, the information may be accessed from wired or wireless stations.

It is an important application of video surveillance to monitor patients in hospitals, clinics, doctor's offices, in the home and the like to monitor their activity while convalescing. Patients may not be stable enough to be mobile by themselves, and they may not be competent enough to know that they should not be mobile by themselves. Video surveillance can thus be an important safety adjunct to patient care. This can contribute to fewer deaths, reduced injuries, reduced convalescence times, and save patients and insurance companies money.

In addition, in light the increasing shortage of nursing personnel, a highly featured video surveillance system can provide a “force multiplier” by giving remote electronic eyes and ears to the staff thus alerting the staff to potentially dangerous situations. This will allow staff to be more productive by arming them with more information.

Also, it is important for patients, patient's families, medical organizations, medical staff and insurance companies to be able to know exactly what happened in the unfortunate situation where a patient is injured. A good video record of factual information on what happened may assist in these situations.

In accordance with the invention, television cameras can be aimed at patient beds or medical stations such as x-ray, MRI, or dialysis stations. Nursing personnel can monitor these stations from a centralized point and watch for dangerous situations. Recording equipment can record archives for future reference if something happens.

In addition, legacy systems such as EKG monitors, oxygen sensors and other apparatus can be incorporated in the system, permitting not only visual assessment of a patient but monitoring of vital signs, as well. This provides real-time or near real-time access to all information, anywhere on the network, as opposed to prior art systems which had limited access usually to local nurse stations and the like.

The subject invention provides several advantages over known monitoring systems by collecting, transmitting and archiving essential data. Among these advantages are:
PREVENTION of medical crisis conditions before they happen, such as preventing patients from falling if they attempt but are not able to get out of bed,
ASSIST first responders in providing rapid and efficient care during crucial emergencies such as cardiac arrest, stroke, pulmonary failure and the like, and
ANALYSIS of events after they occur to understand what happened and train employees.

It is, therefore, an object and feature of the invention to provide a networked surveillance and monitoring system for visually checking the condition of a patient in real-time or near real time anywhere on a network.

It is also an object and feature of the invention to provide a system for archiving and mining the data collected by the surveillance and monitoring system.

It is a further object and feature of the invention to provide a system that collects, transmits and archives medical data over a network in real-time or near real-time.

Other objects and features of the invention will be readily apparent from the accompanying drawings and detailed description which follow.

### BRIEF DESCRIPTION OF THE DRAWINGS

FIG. 1 is an overview of a networked surveillance system, as previously disclosed in my pending patent applications, entitled: Multimedia Surveillance and Monitoring System Including Network Configuration, Ser. No. 09/594,041, filed on Jun. 14, 2000; Method and Apparatus for Distributing Digitized Streaming Video Over a Network, Ser. No. 09/716,141, filed on Nov. 17, 2000; and Method and Apparatus for Collecting, Sending, Archiving and Retrieving Motion Video and Still Images and Notification of Detected Events, Ser. No. 09/853,274, filed May 11, 2001, and incorporated by reference herein;

FIG. 2 illustrates how a camera system may be employed to monitor a patient in a bed within a monitored zone;

FIG. 3 illustrates activation of the system when an event occurs such as entry of a third party into the monitored zone;

FIG. 4 is similar to FIG. 3 and indicates a different event;

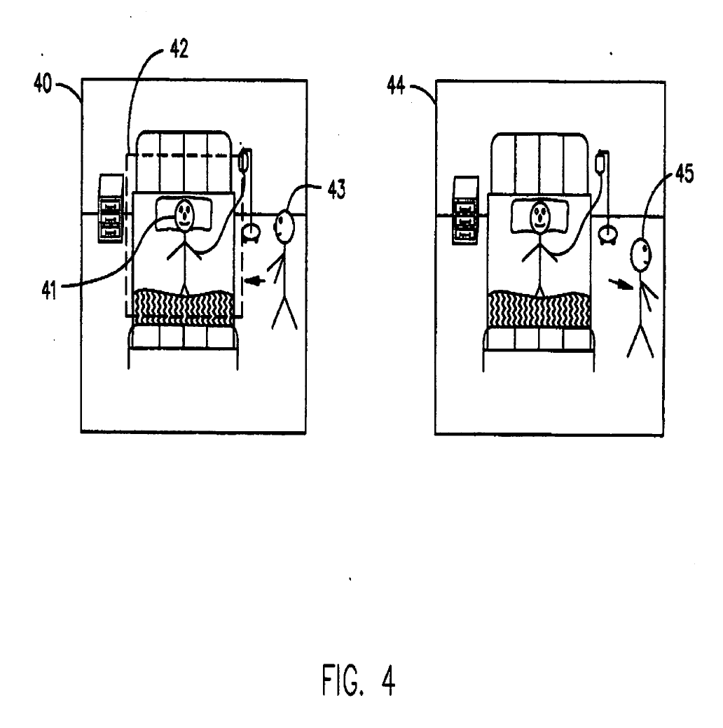

FIG. 5 illustrates the use of identifying tags on authorized personnel to indicate when authorized personnel are within the zone;

FIG. 6 illustrates a typical monitor display;

FIG. 7 is similar to FIG. 6, showing the display upon occurrence of an event requiring attention of personnel;

FIG. 8 illustrates the capability of the system to monitor the precise location of the patient within the monitored zone;

FIG. 9 illustrates the use of color coding to identify the patient, other authorized personnel and their precise location within a monitored zone;

FIG. 10 illustrates the use pattern monitoring to identify the patient, other authorized personnel and their precise location within a monitored zone;

FIG. 11 illustrates the use of facial recognition to identify the patient within a monitored zone;

FIG. 12 illustrates the use of infrared beams to identify the patient within a monitored zone;

FIG. 13a illustrates the transmission of patient information from a patient room to various individuals;

FIG. 13b illustrates the transmission of patient information from a radiology room to various individuals; and

FIG. 13c illustrates the transmission of patient information from an operating room to select individuals.

### DETAILED DESCRIPTION OF THE PREFERRED EMBODIMENT

In its preferred form, the subject invention incorporates IP Video Surveillance Systems including smart cameras that have built in intelligence and IP interfaces. These cameras are incorporated in a network system utilizing centralized servers for managing and recording information which is captured by the cameras as well as legacy system information, where desired. In addition, the system is adapted for presenting video, image and other data to monitoring stations anywhere on the network, or incase of IP based systems, anywhere on the World Wide Web.

One advantage of the smart camera approach is that there is a processor at each camera or camera encoder. This allows sophisticated image analysis to be performed, which can generate alarms as has been described in my previous patents, This decentralized approach allows more sophisticated processing to be accomplished than could be done on a practical basis than could be done on a centralized system.

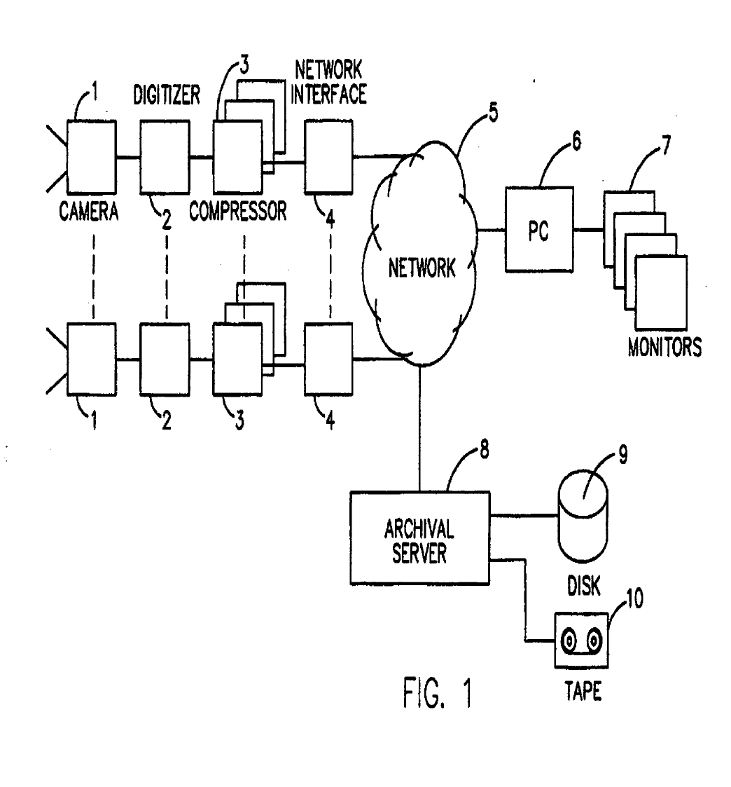

FIG. 1 summarizes the networked surveillance system, as previously disclosed in my pending patent applications, entitled: Multimedia Surveillance and Monitoring System Including Network Configuration, Ser. No. 09/594,041, filed on Jun. 14, 2000; Method and Apparatus for Distributing Digitized Streaming Video Over a Network, Ser. No. 09/716,141, filed on Nov. 17, 2000; and Method and Apparatus for Collecting, Sending, Archiving and Retrieving Motion Video and Still Images and Notification of Detected Events, Ser. No. 09/853,274, filed May 11, 2001, and incorporated by reference herein.

In FIG. 1, a network 5 supports one or more surveillance cameras. Each camera is preferably ‘intelligent’, containing a means for compressing a video signal captured by camera 1, and a means for conveying said compressed visual data via a network interface. In other embodiments of the present invention, analog cameras can be used with a centralized digitizer (which is now often referred to as a networked digital video recorder). Video thus networked may be viewed at one or more monitoring stations 6/7, and may be stored via an archival server 8. The archival server, as described in the co-pending applications, also serves as a central control point for various surveillance network functions. For example, alarm conditions generated by the various cameras or other sensors are processed, forwarded, logged, or suppressed by the server.

In an alternative approach, digital video recorder systems may be employed for archiving and mining. Nevertheless, it should be known that the following algorithms might be applied to either architecture a central based architecture or by employing a plurality of localized digital video recorders.

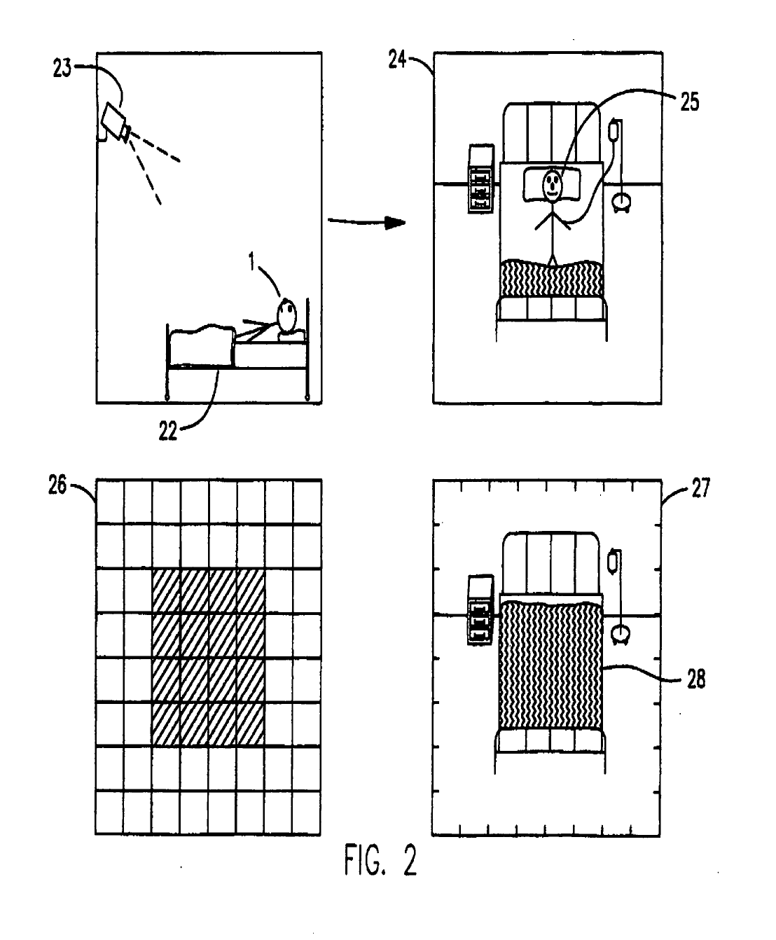

The subject invention utilizes known techniques in video surveillance coupled with the unique needs of a medical monitoring environment. Initially, an authorized patient zone is defined. A system of previous patent disclosures including Ser. No. 09/853,274 can define a video zone and generate alarms if video motion is detected in that zone. For example, a video camera is trained on a patient in a bed. A “Safe Zone” is established where the patient lies and a small perimeter of reach around it. When the system is armed, if there is motion outside of the safe zone the detection software will detect it and generate an alarm. This is illustrated in FIG. 2. Patient 21 lies immobile in bed 22, and is viewed by networked camera 23. The resulting scene 24 depicts the immobile patient 25 lying in the bed. It is desired to automatically detect attempts by the patient to exit the bed.

This is accomplished through the use of video motion detection. An image-processing algorithm measures successive inter-frame differences of each pixel, thereby effectively detecting motion within a video scene. This algorithm may be preferably executed within the camera viewing the scene, or alternatively be executed on a centralized network server. It is obviously advantageous to execute the algorithm within the individual camera, to avoid excessive computational load on a centralized processor. However, the net result is functionally equivalent.

However accomplished, motion detection can be used to generate an alarm when the televised patient moves. This alarm may take a number of forms, the most useful of which is to create an audible alert to operators at a monitoring station, and to cause that camera's video to appear on the monitor station.

This particular method will generate an alarm any time there is motion at any location within the monitored zone. For example, a patient rolling over in bed or adjusting the pillow could generate an alarm. While useful in critical care situations, in many instances such a motion would be viewed as a false alarm. These false alarms would constitute a nuisance to the supervisory staff, and indeed may compromise the care of other patients.

One resolution of this “false alarm” is through the use of a virtual mask, superimposed on the video scene. Again in FIG. 2, grid 26 represents the overall video image, divided into segments. These segments may be individually selected by an operator, to enable or disable motion detection on the corresponding portion of the video scene. As shown in FIG. 2, for example, a number of segments in the central area of the grid are selected, to inhibit motion detection from those equivalent regions of the video scene. Correspondingly, video scene 27 shows an area roughly corresponding to the bed and patient, which have been de-selected for motion detection. Motion within these regions will not produce an alarm. This effectively prevents ‘nuisance’ alarms from being generated by normal movements of the patient while in the bed. If, however, the patient attempts to leave the bed, or perhaps falls from the bed, this motion will be outside the ‘masked’ zone within the video scene, and will generate the desired system alarm.

Note that this system of selectively masking the scene may additionally suppress video from the corresponding region of the video scene. This may be advantageous to enhance patient privacy, if so desired or if medically appropriate.

In another aspect of the invention, it may be desirable to suppress the alarm when authorized personnel are in the zone and outside of the Safe Zone, i.e., to deactivate the alarm when authorized personnel are present. In this case the video processing system will track these personnel as “objects”. When a person is in a bed and the system is activated, any motion outside of the Safe Zone and moving outward from the bed will cause the alarm. If there is motion from the periphery of the image toward the bed, that is a visitor or medical person, and an alarm will not be generated.

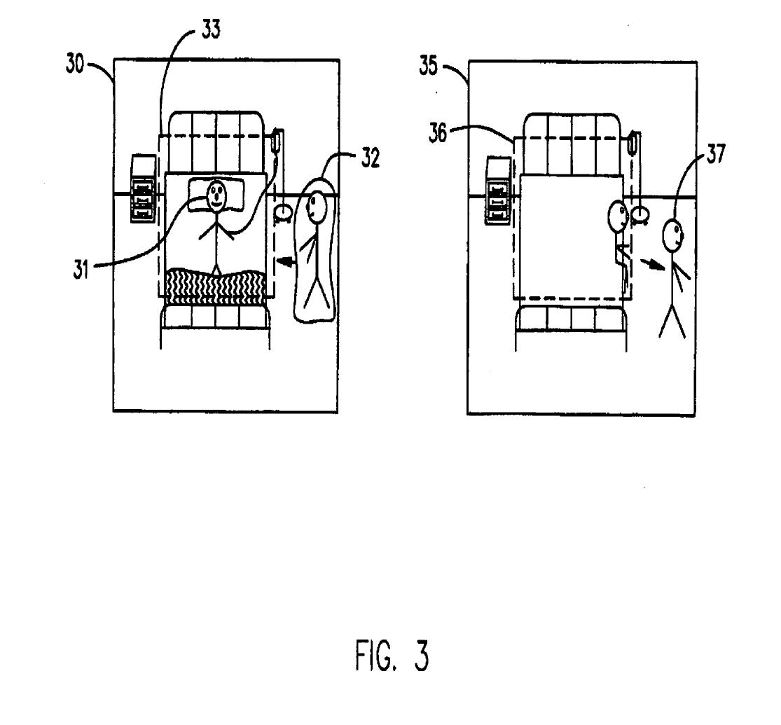

As shown in FIG. 3, scene 30 depicts patient 31 lying in bed, while a second person 32 enters the room and approaches the bed and, in particular, approaches the pre-defined motion detection zone 33. Image processing algorithms, executing within the local camera or on a remote processor, can easily detect this moving object (the person), and determine the direction of the person's movements within the room. Since the person 32 has moved from the periphery of the scene, and moved towards the bed, it may safely be assumed that this person is not the patient. Accordingly, the system will not generate any alarm for the supervisory staff.

Conversely, in scene 35, the bedridden patient 37 is seen to rise from the bed and move towards a door. Again, image-processing software can easily detect this moving object, which this time originated within the pre-defined motion detection zone 36 and is moving towards the periphery of the scene 35. Since this motion has been determined to be away from the pre-defined zone 36 and towards the periphery of the scene, it may be safely concluded that this motion is that of the patient, trying to leave. The system may thereupon generate an alarm to supervisory personnel, with improved confidence that the motion detected is that of the patient, leaving the bed.

In another example a visitor may enter the room, and approach the bed. The algorithm recognizes ‘motion towards bed’ and does not generate an alarm. When said person thereupon leaves the bedside and walks away, the algorithm recognizes ‘motion away from bed’ and produces an alarm. Therefore, system algorithm may be modified such that a person may move towards the bed, then subsequently move away from the bed without generating an alarm. If it is subsequently detected that a second person is moving away from the bed, then it may be safely assumed to be the patient and the alarm event will be generated.

As shown in FIG. 3, scene 40 depicts patient 41 in bed, which has been delineated by motion detection zone 42. Visitor 43 enters the room and moves towards the bed. The motion analysis algorithm recognizes visitor 43 as a moving object, moving towards the bed. Since the moving object is moving towards the bed, the algorithm does not generate an alarm indication due to this detected motion. In scene 44, the visitor 45 moves away from the bed. The algorithm can deduce, with some degree of certainty, that moving object 43 is the same as (subsequent) moving object 45. The algorithm accordingly does not generate an alarm condition when it detects moving object 45 moving away from the bed, since it has deduced that it is a visitor and not the bedridden patient.

If a second visitor or medical personnel enters, the equation gets even more complicated. In this case it may be desirable to disable the video alarm system when visitors or medical personnel are present. This can be done by requiring medical staff and visitors to wear RFID tags. When they are in the proximity of the patient, that will be detected by the RFID tag and it is assumed that they are assisting the patient and the video alarm is deactivated. When no tag or tags are near, any video alarm is passed.

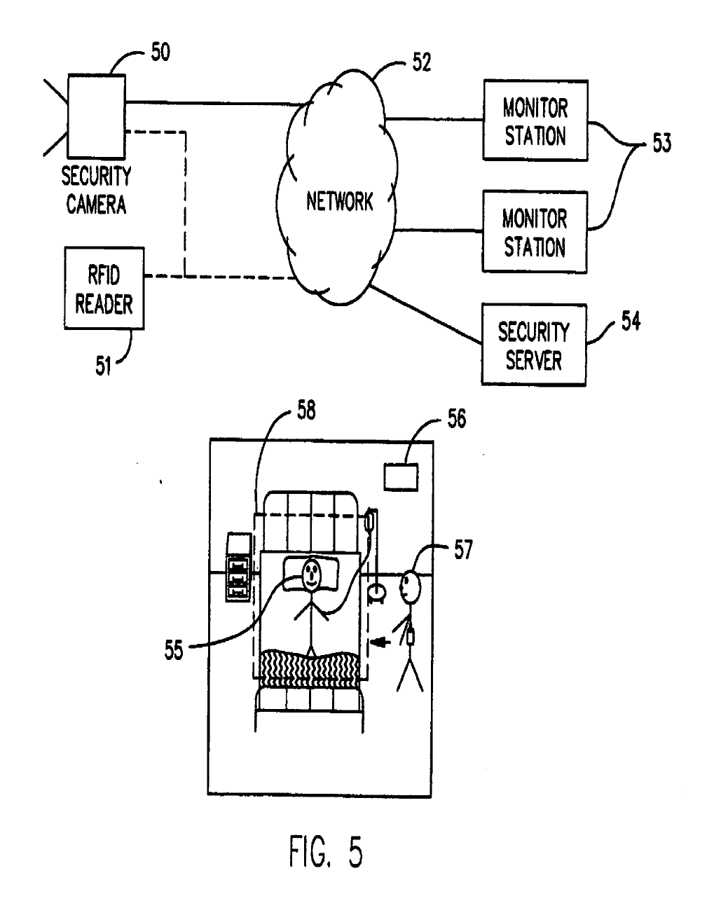

As shown in FIG. 5, the surveillance camera 50 is connected to a Local- or Wide Area Network 52. Video thus generated is viewable on one or more networked monitoring stations 53. Said video may also be archived on networked security server 54. The security server 54 may also serve to monitor and control various security-related functions of the networked devices. The server may, for example, receive ‘motion detected’ messages from the various cameras, and may thereupon notify one or more monitor stations of the event.

In the present invention, an RFID reader 51 is added to the network, in the immediate vicinity of the patient 55 and the bed. The RFID reader 51 may be attached to the camera 50 itself, or may have its own network connection. In the preferred embodiment, the RFID reader 51 is attached to the local room camera 50. This insures that the reader's ‘tag detected’ output is correlated with the particular camera. In the alternative embodiment, the RFID reader 51 is attached directly to the network 52, whereby it is logically connected to the networked security server 54. In this embodiment, it becomes the responsibility of the networked server 54 to correlate the various RFID readers with the various networked security cameras. This may be troublesome to maintain, as the various cameras and RFID readers may be serviced or replaced. In either case, however, the concept of the invention is the same: the RFID reader is logically correlated with a particular networked security camera.

The bedridden patient 55, as is his habit, lies in bed and normally stays within the confines of the pre-determined motion-detection-masked zone 58. An RFID-badge-bearing visitor 57 enters the room. The video motion-detection algorithm, either inside the local camera or in a networked processor, would normally detect the visitor's motion, which is outside the pre-defined motion-detection-masked zone 58, and generate an alarm. In this case, however, the local RFID reader 56 detects the visitor's presence, and passes this information to the mom camera. The camera's motion detection algorithm is thereupon instructed to not generate or send any ‘motion-detected-outside-zone’ alarm messages to the security server 54 or to any monitor stations 53.

On the other hand, if the camera's motion detection algorithm detects any ‘motion-outside-masked-zone’ while the RFID reader 56 is not detecting any valid tags, then said motion may be safely assumed to be that of the patient 55, outside of the pre-defined motion detection masking zone 58. An alarm message may be thereupon generated and sent to the appropriate network recipients, with a high degree of confidence.

It should be noted that the ‘valid badge detected’ output from RFID reader 56 may also be used to cause logging or recording of the room camera's video. This may be useful, for example, to provide a visual record of patient care.

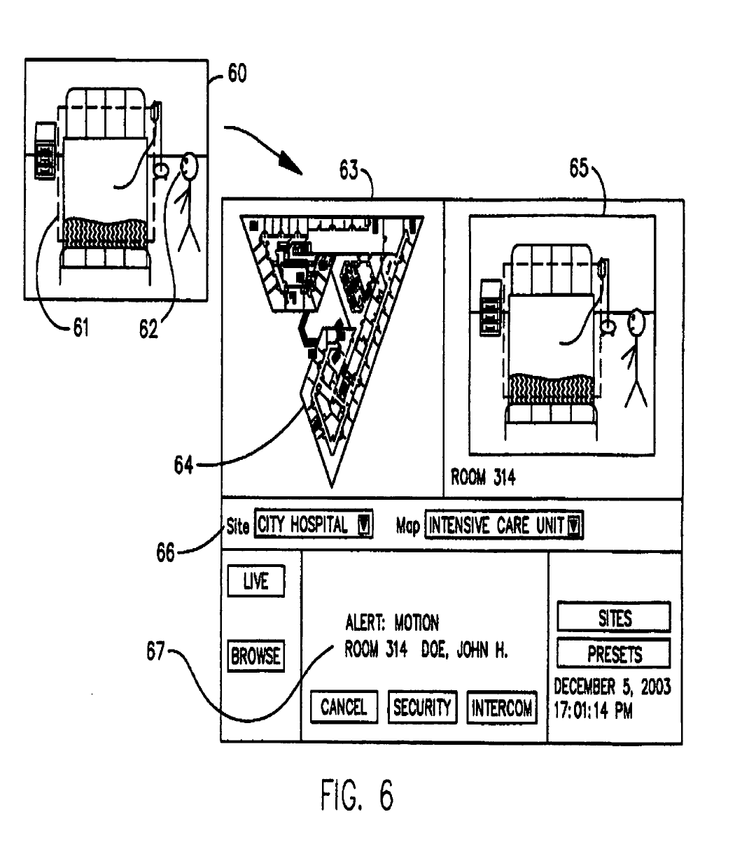

In the preferred embodiment, the image captured from the camera associated with an alarm is automatically presented to a monitor station for human observation. The incorporated applications disclose a means for automatically displaying, on one or more networked monitoring stations, video from cameras that produce alarms. Accordingly, FIG. 6 depicts scene 60 in which patient 62 has left the bed 62. The previously described motion detection algorithm detects inappropriate motion in the room, and sends an alert message to the networked security server and networked monitoring stations. The networked security server instructs one or more networked monitoring stations to immediately display the camera's video, as depicted on networked monitor station screen 63. As shown, the monitor station screen 63 contains several fields, including floor map 64, map selection buttons 66, camera video 65, and alarm field 67. The monitor station has been commanded to display the live video from the camera that has produced the motion alarm. Control buttons in the alarm field identify the room and patient, and provide several control buttons with which supervisory personnel may respond to the alarm.

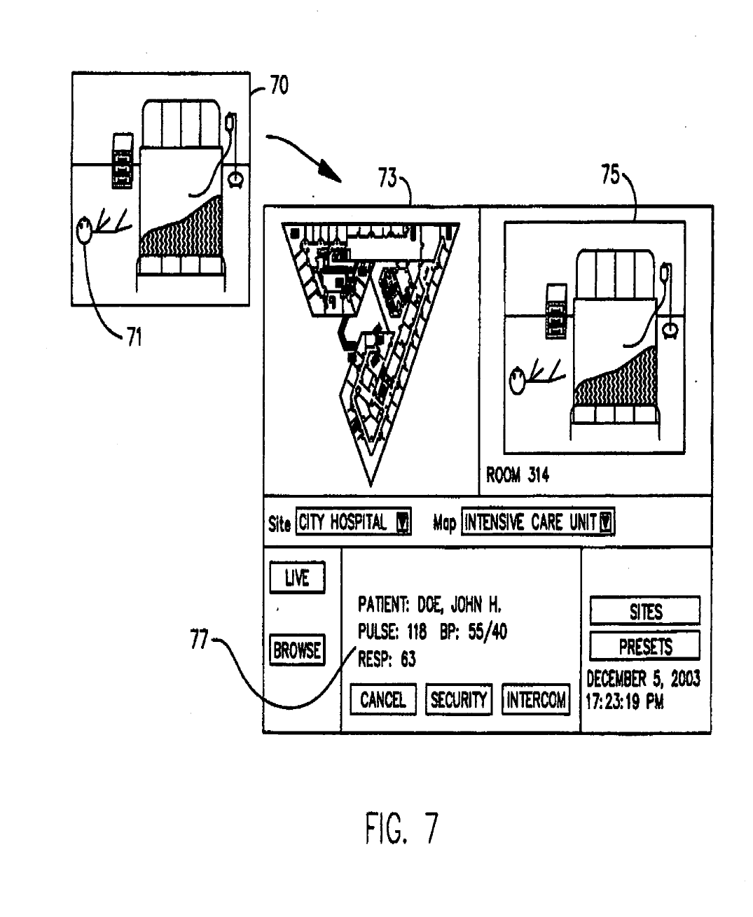

As previously stated, legacy systems may also be incorporated in the system permitting the associated information to be displayed along with the video image such as audio and vital signs information as is collected by other medical instrumentation. The patient may be equipped with monitors to measure heart rate, blood pressure, temperature, respiration, and a variety of other medical parameters in the well known manner. These monitors are often wearable, allowing patient mobility, and may be connected via wireless network to a monitoring station. In the present invention, medical data thus networked may be displayed on a security monitoring station screen when the camera generates an alarm. For example, as shown in FIG. 7, patient 71 has fallen from bed in scene 70. The video surveillance camera in the patient's room detects motion outside of the masked region, and generates an alarm. Monitoring station, screen 73 immediately displays video from the camera, and displays various medical data in the alarm panel 77.

In a variation of the same invention, the alarm data may be derived from the medical data, and thereby cause an alarm on the networked monitoring station. Since the medical data is networked, an appropriate network server may analyze the medical data, and generate an alarm upon detection of an abnormal medical condition. This alarm condition may be used to trigger the immediate display of the patient's video and vital signs as before.

In one aspect of the invention an RFID tag may be located on the patient in conjunction with an intelligent camera or DVR system. The sensor will be of a type that can locate position with precision within a room and be able to distinguish when a patient is in a bed or not, in a machine or not. An example of this technology is the “Wideband Sensor” whereby a microwave “chirp” is extended to the tag. The return from the tag is communicates sufficient information to locate the tag within the space. The permitted zone is defined in the geo-location plane (or sphere). The exact location of the patient is determined by the Wideband Sensor and compared with the software to the permitted zone. If the patient is found to be out of the permitted zone, an alarm event is indicated. The event activates the monitoring console and switches to the camera that is in the zone of the patient.

Emerging ‘Ultrawideband’ or UWB technologies provide a means to locate an object or person in space, with unprecedented accuracy. Traditional RFID techniques were capable of locating an object to within several feet; UWB approaches provide positional accuracy's of several inches. With that degree of accuracy, a patient's location may be determined with enough accuracy to determine if they have fallen from the bed; or perhaps are leaving the room.

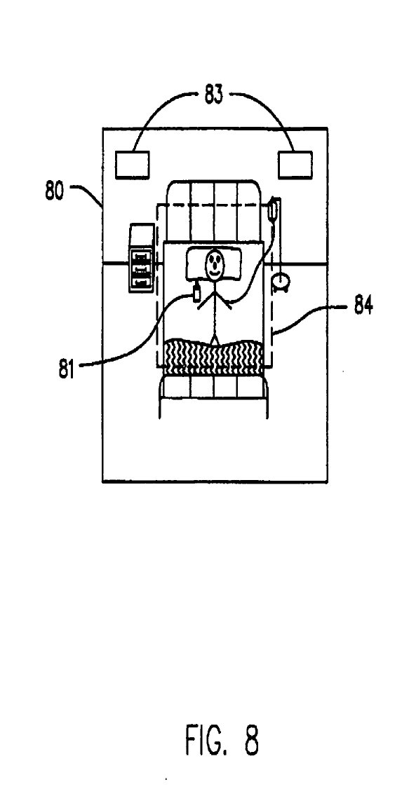

As shown in FIG. 8, in scene 80, a UWB/RFID transponder 81 is attached to patient 82. The transponder may take the form of a small badge, wrist bracelet, or may be sewn into the patient's garment. One or more UWB/RFID readers 83, located near the patient's bed, continually monitor the location of the patient's UWB/RFID transponder. This location data is continually passed to the intelligent camera, which is located within the room and which continually monitors the bed and patient. If the camera is a movable tilt/pan camera, the camera may be commanded to move to the current UWB/RFID transponder location, thereby following the patient's movements.

The camera is pre-conFigured with data describing an ‘acceptable’ location 84 for the patient. The camera thereby generates an alarm condition when the patient's location is outside of this pre-determined limit. When the camera generates the alarm condition, it includes the UWB/RFID transponder location data in the alarm message. The networked security server and networked monitoring station may thereby keep track of the patient's current location. If the patient leaves the immediate room and moves to a different area, the UWB/RFID tracking data may be used to cue a different camera, thus providing real-time visual monitoring of the roving patient. Additionally, patient movement data and various medical data such as vital signs may be displayed on the networked monitoring station, and may be recorded on the networked security server.

In yet another aspect of the invention, image processing color recognition algorithms may be used to identify the patient by color of clothing. The patient will be issued a gown of a specific color. The video processing system will analyze the color of the scene and electronically filter the video detecting the color specified for the gown. The filtered image will then be passed to the motion detection algorithms for processing in the manner described above. This will allow for detection of a patient that is outside of the Safe Zone without worry of detecting visitors or medical personnel. For this scheme to work with minimal false detections, the color of the gown must be different than the color of clothing worn by medical staff or visitors. The color-detecting algorithm can be made more or less specific by adjusting the threshold in the color comparison algorithms.

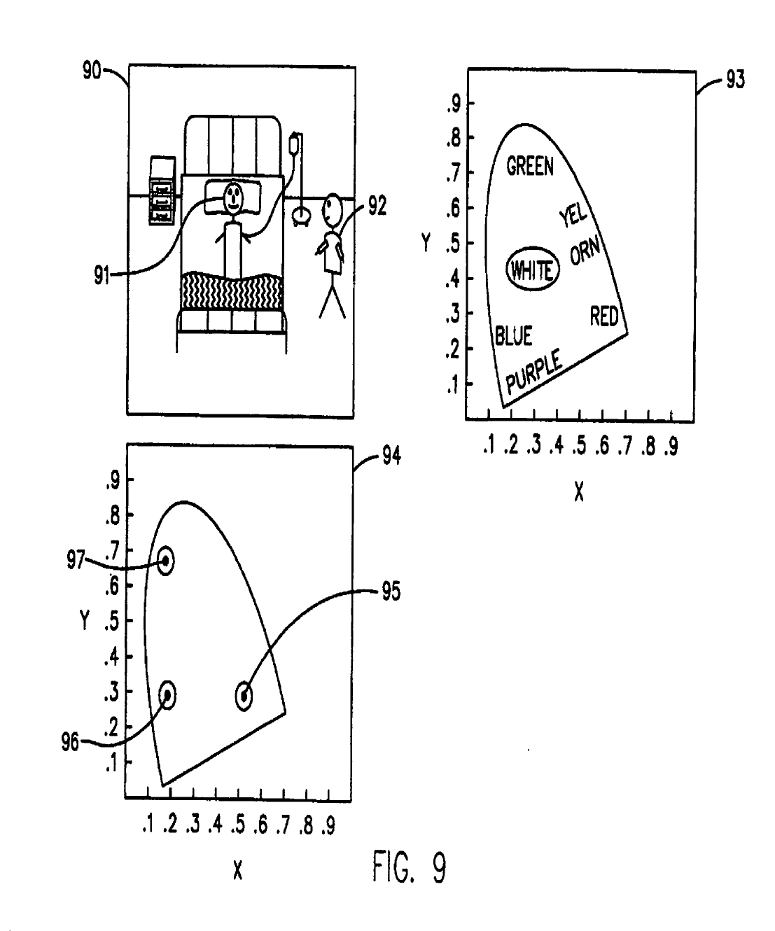

As illustrated in FIG. 9, scene 90 depicts recumbent patient 91 bedecked in a hospital gown, of a specific pre-defined color. Visitor 92, a care provider, is clothed in a gown or other garment of a different color. The colors are pre-selected according to some defined rules. For example, patient's clothing may be red, surgical staff may be green; nurses or orderlies may be blue, and so on. The intelligent camera captures a scene from within the room, then digitizes and compresses the captured video. As part of the digitization process, chrominance data is extracted from the scene. This color data describes the location of each picture element in terms of its location within a pre-defined ‘color space.’ Such a color space may be represented using several different standardized methods, for example the CIE 1931 color space as shown in 93. In this form of representation, two of the three primary colors are combined to form each axis, thus allowing the mapping of three-color coordinates into a two-dimensional space. In the color space shown, white items occupy the center of the diagram; each radial direction outwards from ‘white’ represents a color, and the distance from ‘white’ represents color saturation. Using this color space, any specific color may be depicted as a point within the color space.

As part of the compression process, the scene is divided into a large number of blocks, typically containing an 8×8 block of pixels. Each pixel within the block is described by a luminance value and a chrominance data pair. During compression, this 8×8 pixel block is transformed, typically using a Discrete Cosine Transform, into a series of 8×8 tables representing the spatial spectra present in the original block of pixels. Typically, such a transform is performed on the luma and chroma data separately. The resulting compressed chroma tables describe the predominant color present within each 8×8 block of pixels.

Having the above data, it is possible to detect specific colors, and to localize their position within a given scene. In the invention, the camera is pre-programmed with data, descriptive of certain predefined colors such as the coded garment colors previously described. A color-matching algorithm executes within the camera. This algorithm evaluates the color captured within each block of pixels, and determines whether the block contains colors that agree with the camera's pre-programmed color-matching data For example, color space 94 contains shows several color values 95, 96, and 97, which represent the pre-defined garment colors. For example, color 95 is red, which may correspond to the pre-defined red garment color worn by patients. Likewise, color 96 is blue, corresponding to the pre-defined garment color worn by nurses, and color 97 is green, corresponding to surgical staff garb. Each of these color coordinates is surrounded by a circle, which represents the algorithm's decision threshold. In other words, if any color captured by the camera falls within the particular circle, the algorithm will assume that the captured color matches the pre-defined ‘matching’ color.

The algorithm, therefore, can identify the presence and location of any pre-defined colors within the scene. Upon detection of a color corresponding to a patient, the algorithm compares the position of that color in the scene to a set of pre-defined bounds. If the detected color (the patient) is outside of the pre-defined bounds, an alarm signal is generated and transmitted to the security server, and to one or more networked monitoring stations. Note that the color sensitivity of the algorithm is adjustable, simply by re-defining the radius of a color's ‘decision circle’ in color space.

The invention supports advanced video processing that will further increase the accuracy in detection by providing a gown for the patient that has a pattern imprinted upon it that can be recognized by the image processing algorithm. This pattern can be unique such that everyday clothes worn by medical personnel and visitors would be highly unlikely to be recognized by the pattern matching algorithm. The image-processing algorithm will filter the image based on the pattern, and present the filtered images to the motion detection algorithms to determine the location of the patient. These algorithms can then be further utilized to determine if the patent is inside or outside of the safe zone as described above.

As previously described, video compression algorithms divide a scene into a collection of blocks, each of which is 8×8 pixels in extent. These blocks are then transformed into the spatial frequency domain, typically through the use of a DCT or Wavelet transform. In the networked security surveillance camera previously described, this purpose of this video compression is to reduce the bandwidth requirements of the image transmission, mainly by discarding excessive higher-frequency data within the transformed blocks. However, since the transformed image data is available, it is possible to process the video data locally, within the camera, for a variety of purposes. One of these purposes is that of detecting or matching visual patterns within the scene. In the invention, such pattern matching is used to locate patients or staff personnel, by means of pre-defined patterns on the person's garments.

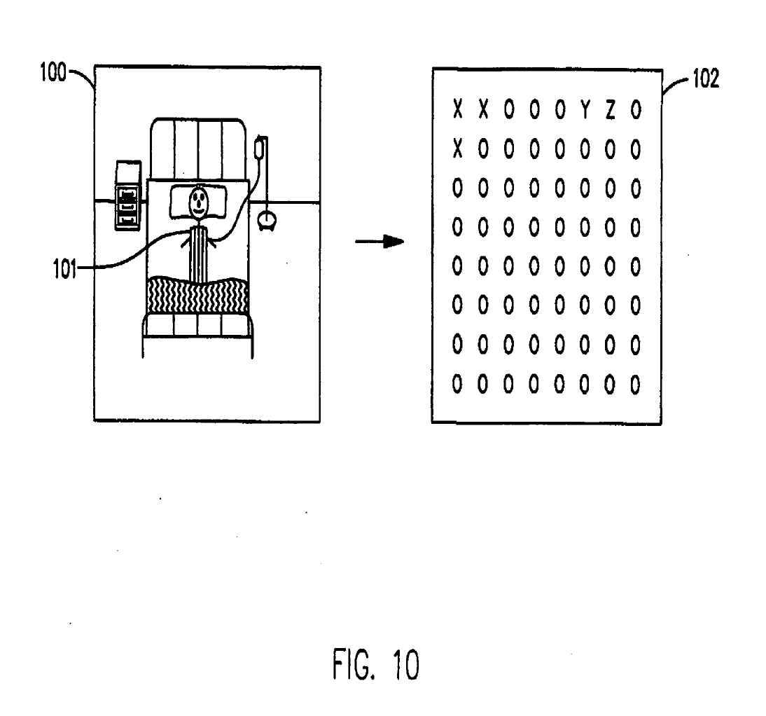

A simple vertical bar pattern is one example, see FIG. 10. Scene 100 contains bedridden patient 101. The patient's hospital gown or robe has been manufactured or dyed with a series of vertical stripes of high contrast. The video data representing the patient's garment, after transformation to the spatial frequency domain, will exhibit low spatial frequency in the vertical axis, and will have significant and detectable spatial frequencies in the horizontal axis. In fact, several of the 8×8 blocks in that general region will exhibit the same (or similar) spatial frequency characteristics. For example, transformed data block 102 exhibits several terms with a value of X, occurring near a zero horizontal and vertical frequency. These terms represent the overall, average luminance value of the block. All other terms are zero, with the exception of some higher-frequency terms Y and Z in the horizontal direction. These terms Y and Z may be easily distinguishable as being characteristic of the pre-defined pattern on the patient's garment. An algorithm, executing locally in the networked security surveillance camera, detects these unique spatial frequency characteristics. Since these 8×8 blocks, containing the ‘matching’ spatial frequency, are located within the pre-defined ‘safe’ boundary of the image, the camera's algorithm generates no alarm. If a significant number of transformed 8×8 blocks exhibit these detectable spatial frequency characteristics, and are located outside of the usual pre-defined ‘acceptable’ zone, then the algorithm concludes that the patient has left the bed, and generates the alarm as before.

Other visual patterns are possible may be used, as well. For example, a series of horizontal stripes on the patient's garment would exhibit small spatial frequency components in the horizontal axis, but large components in the vertical axis. Or, a polka-dot pattern would, after transformation, exhibit effectively equal spatial-frequency components in both axes. In any case, the camera's pattern-matching algorithm attempts to match these spatial frequency characteristics to a pre-defined pattern, and generates an alarm if a match is found outside of the predefined area of the image.

Note this technique presents problems of orientation and scale. For example, if the patient leans over, or positions himself diagonally in the bed, then the stripes on the garment are no longer oriented horizontally. Likewise, if the patient moves closer to or farther away from the camera, then the effective spatial frequencies of the pattern change correspondingly. In other words, any pre-determined visual pattern on the patient's clothing will not be scale- or orientation-invariant after the image has been transformed. Such problems, however, are well understood and may be easily overcome through the use of a variety of algorithms, including well-known morphological filtering techniques.

Specifically, the preferred embodiment of the invention includes a more advanced pattern on the gown such that individual classes of patients or individual patients can be identified. For example the gown can be imprinted with a bar code to allow individual identification. The gown can be imprinted with multiple bar codes such that the patient can be identified when in any position.

Different types of visual patterns may be defined for different categories of patients or staff personnel. It is only necessary that the patterns be algorithmically distinguishable after transformation to the spatial frequency domain. So, for example, patients in one category may be identified with stripes, while another category may be distinguished with polka-dots. Yet another category may be distinguished with a crosshatch pattern. In any case, the spatial frequencies of these visual patterns are mutually distinguishable, thus enabling the camera's pattern-detection algorithm to identify the patient's class. As before, detection of such a pattern outside of pre-defined boundaries causes the camera to generate the alarm to the networked server and monitoring stations.

The invention provides an image processing algorithm that will be aware of diminishing size blobs of color or pattern and treat that as a normal event. This will allow a patient to cover up in bed without the system generating an alarm. The system can additionally keep track of the last known locations for the color or pattern and as an assumed location of the patient. The location would be updated if that specific color or pattern appears anywhere else in the scene.

The patient's garment is, as previously discussed, detectable and distinguishable by the camera. As before, this may be accomplished either through the use of unique and distinguishable colors, or by pre-defined and distinguishable geometric patterns on the patient's garment. If, as suggested, the patient pulls up the bed covers and thereby obscures, the distinguishable color or pattern, the camera obviously ceases to detect the unique color or pattern. However, the camera's algorithm maintains a record of the last-known location of that specific color or pattern. The camera, upon inquiry from the networked server, provides this ‘last-known-location’ datum to the server or monitoring station. If the pattern or color subsequently re-appears within the scene at the same or similar position, then the algorithm need not generate an alarm. If, however, the pattern re-appears elsewhere in the scene, outside of the pre-defined ‘accepted’ zone, then the camera's algorithm generates the alarm.

In another aspect of the invention patient location is tracked with facial recognition in a manner similar to tracking people in the aforementioned copending security patent application 60/428,096. Facial recognition is an emerging technology that is gaining acceptance in a variety of security applications, including airports, sporting events, and gaming casinos among others.

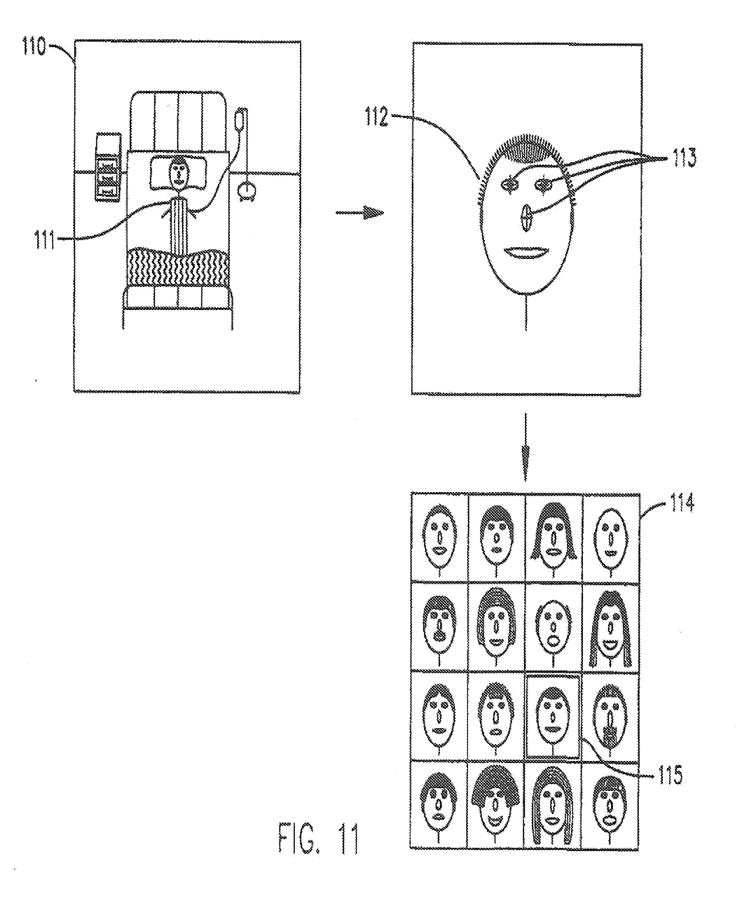

The present invention uses facial recognition as illustrated in FIG. 11, in conjunction with the intelligent, networked security surveillance cameras, in a health-care setting. The invention enhances patient security and quality of care. As there shown, in the invention, a camera captures a scene 110, which contains the bedridden patient. Inside the ‘intelligent’ camera, a face-detection algorithm analyzes the scene, and locates a human face 111 within the scene. The algorithm subsequently ‘normalizes’ the size of the detected face 111, which simplifies subsequent facial feature extraction and pattern matching. After normalization, the algorithm analyzes normalized face 112, and identifies salient facial features 113, which in this example includes the eyes and the tip of the patient's nose. Once the patient's face and facial ‘landmark’ features have been identifies, the algorithm analyzes the face and extracts other characteristic features, depending upon the specific algorithm in use. For example, distance from eyes-to-side-of-head may be calculated, or distance from eyes-to-top-of-head may be calculated. In any case, the facial data thus extracted, and the location of that face within the scene, is conveyed via the intervening network to the networked security server. The security server contains a database 114 of known faces. A matching algorithm in the server attempts to match the normalized and analyzed face, captured by the camera, with one of the faces stored in the server's database. When a match is found, the server has identified the bedridden patient 111.

The server, knowing the identity of the detected face and its location within the scene, determines if the patient has strayed outside some pre-determined bounds. If the patient is located outside of these pre-determined bounds, an alarm is generated as before. Similarly, if the patient's face is not detected within the pre-determined, bounds, an alarm may likewise be generated, and staff personnel alerted.

It should be noted that the detection, analysis, and matching algorithms previously described may be located in various places within the networked system, with similar results. For example, if the networked security camera is equipped with sufficient computational power, then all three algorithms may operate within the camera. Conversely, is the camera has minimal computational power, then the networked security server, or other networked processor, may receive the camera's video and perform the detection/analysis, and database matching, again with similar results.

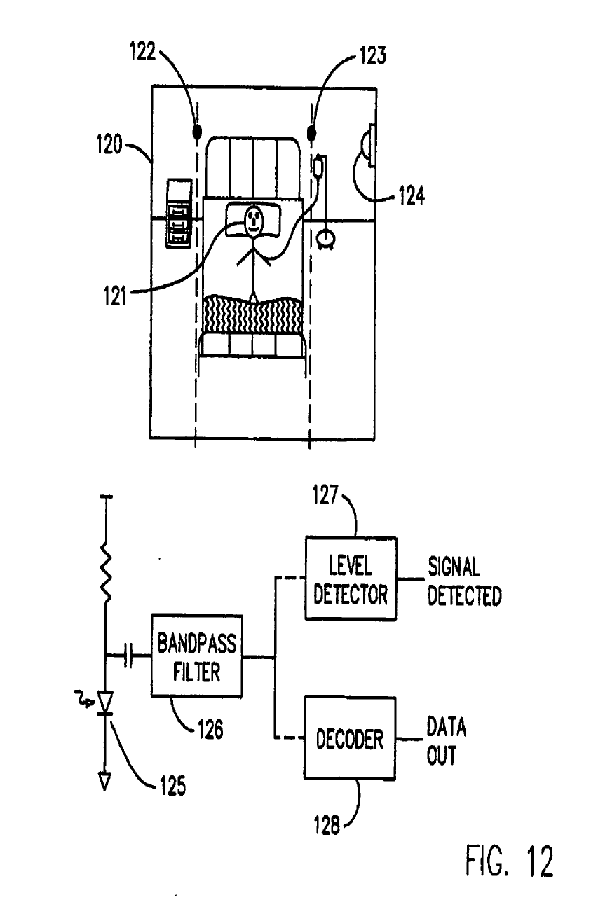

The invention further includes the capability of detecting the patient's attempts to leave their bed through the use of modulated, and possibly coded, infrared beams, which are positioned on either side of the patient's bed and are vertically swept or fanned to produce a virtual plane. As shown in FIG. 12, scene 120 depicts patient 120 in bed. Infrared emitters 122 and 123 are positioned nearby. These emitters 122 and 123 may be attached to the wall behind the patient's bed, several inches on either side of the patient bed. Alternatively, emitters 122 and 123 may be attached to the bed's frame, again positioned to be several inches on either side of the bed. In either case, emitters 123 and 124 produce a ‘fan’ beam, in a vertical plane several inches on either side of the bed.

The ‘fan’ beam may be produced in a variety of ways. If the infrared source is a coherent source such as a laser diode, then the fan may be produced using holographic or diffractive filters. This is commonly seen on small handheld laser pointers, which often have changeable filters which produce a variety of beam patterns. If the light source is not coherent, the fan beam may be effectively produced by shining the beam through a narrow aperture, or by mechanically scanning the beam.

However produced, the pair of fan beams form a virtual ‘wall’ on either side of the patient bed. Normally, there is no object in the room positioned within the plane of the beams. If, however, the patient attempts to leave the bed, the patient will pass through one of the beams, and will be illuminated by the beam. When this happens, detector 124 detects the illuminated object in the room, and generates the alarm as previously described.

It should be noted that detector 24 needs to have a restricted area of coverage, rather than a simple hemispherical response. For example, the fan beam cannot be prevented from striking the floor, or ceiling, or opposite wall. If detector 24 had a fully hemispherical response, it would detect the beam as it struck one of those surfaces. It is therefore necessary to limit the detector's angular area of coverage to a smaller solid angle, preferably a solid angle positioned immediately above the bed.

Additionally, detector 24 must be immune to the presence of ordinary light sources such as the room illumination or ambient light from outdoors. This is easily accomplished by endowing the fan beam light with some distinct and non-natural feature. For example, light amplitude 125 is shown modulated sinusoidally, at some frequency high enough to be unmistakable from other light modulation frequencies, e.g. 60 Hz (power) or 15.75 kHz (common video). If detector 24 is equipped with a simple optical level detector, and a subsequent AC-coupled bandpass filter matching the fan beam's modulation frequency, then detector 24 may effectively and reliably distinguish the fan beam from other light sources.

For example, the optical detector may be a simple photodiode 125, capacitively coupled to a bandpass filter 126, which matches the modulation frequency of the infrared beam. A simple level detector 127 may then be used to produce a reliable indication of the presence of the modulated infrared signal, which in turn indicates that the patient (or other person) has crossed the fan beam.

Additionally, the fan beams may further be coded with some distinguishable on-off bit pattern. This may be similar to the coding schemes used in everyday infrared remote control devices. Typically, the raw infrared signal is encoded with some binary data pattern, which consists of the binary-weighted presence or absence of some constant frequency signal, which in turn modulates the infrared transmitter ON or OFF. This common technique is of value in the present invention. For example, the fan beams may be binary-coded with the patient's room number, patient name or other useful data. In FIG. 12, the output of the bandpass filter 126 is passed to a simple binary decoder 128, which decodes the binary encoding pattern of the original fan beam.

Patient privacy is of utmost importance. In another embodiment of the present invention, access to patient video and/or patient information is automatically transferred to the present location of the patient. For example, a patient is admitted to the hospital and it is specified which doctors, nurses and family members have access to the patients information. One such feed can be video or images from a camera. Another such feed might be medical telemetry such as real-time EKG data streams. Another feed might be scanned, transcribed, dictated, or typed nursing records. Based upon the specified authorized viewers, these feeds will automatically be routed to the proper viewers, and access denied to all others. The viewers may be located anywhere, internal or external to the medical facility.

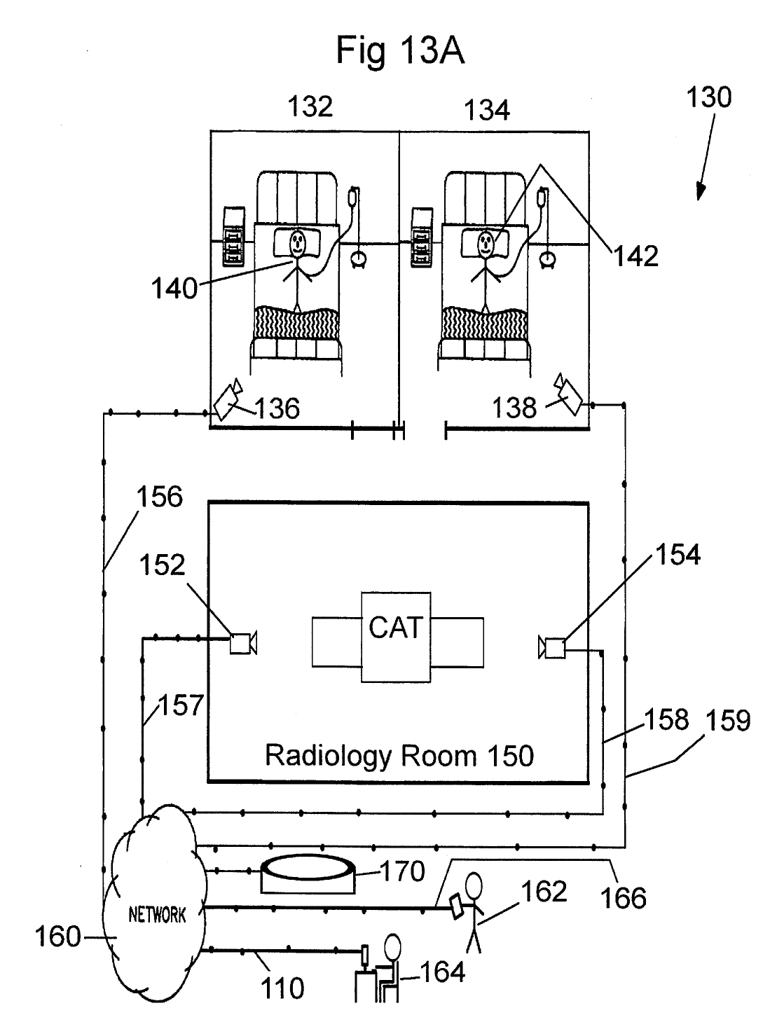

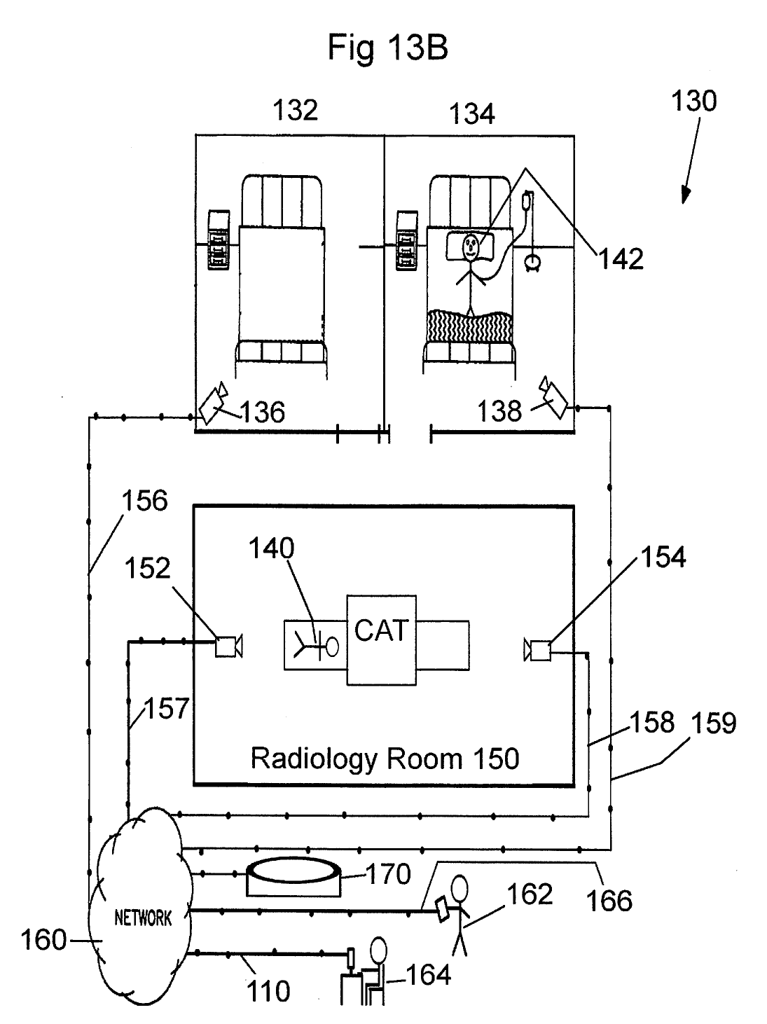

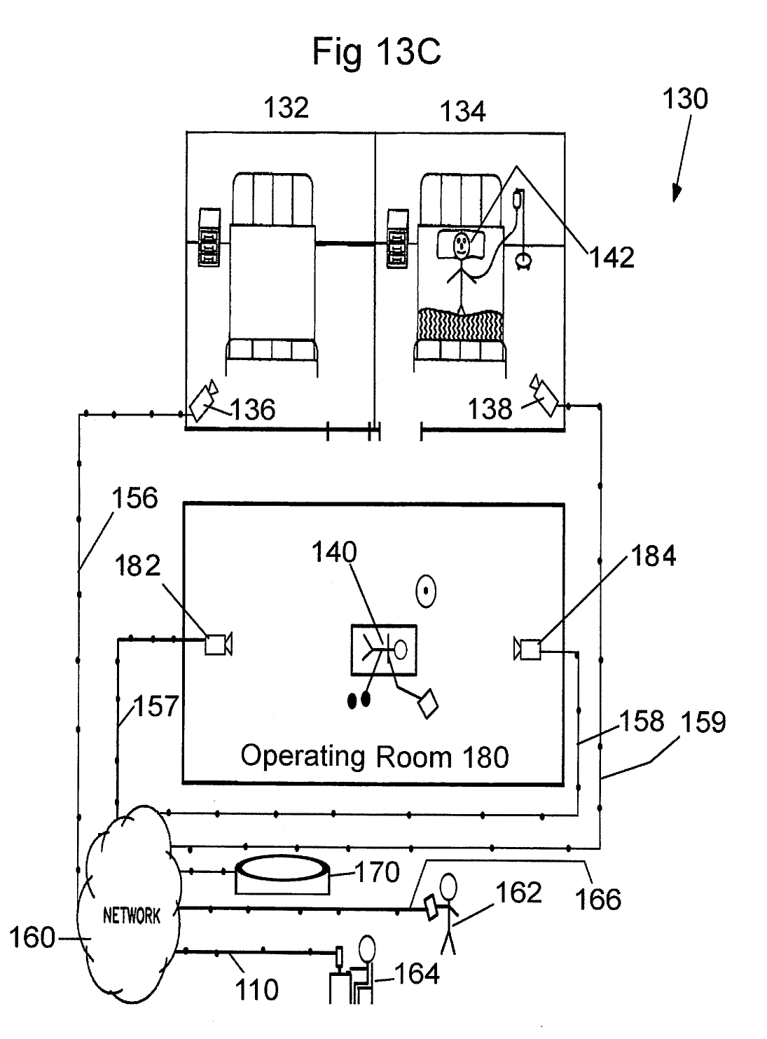

For example, in FIGS. 13A, 13B and 13C, John Jones 140 is admitted to Edison Memorial Hospital. All of the cameras in the medical facility, 136, 138, 152, 154, 182 and 184 are networked on the Hospital LAN. The Hospital LAN has W-LAN (Wireless LAN) capability as well as wired capability. The Hospital LAN also has a gateway into a WAN (Wide area Network) such as the Internet. Attached to the Hospital LAN is a server or battery of related servers, that are responsible for the admission of the patient, IP video surveillance, medical records and the like. Also on the server is software is application software that controls access to cameras that is described in at least one of the above cross-referenced patent applications.

Referring to FIG. 13A, upon check-in patient 140 is sent to patient room 132 which is equipped with camera 136. Also, upon check-in, patient Jones is assigned to Dr. Matthews 162 and record is made that his spouse is Jill Jones 164, and that Mrs. Jones is to have access to Mr. Jones' records. This is recorded on the computer or server that processes admissions and retains recorders during the patient stay. The server that controls the hospital camera surveillance system is in communication with the information from the admissions records and it, in real time, controls who has access to the video feeds at any given time. It, or other similar servers, also can control who has access to medical telemetry, medical notations and the like in a similar manner. For example, there may be an x-ray/MRI server that collects medical images associated with Mr. Jones. Access to these may be similarly “switched” to the Doctor who is officially assigned to Mr. Jones.

Again referring to FIG. 13A, it is shown that Patient Jones 140 video as is captured by camera 136 is automatically passed through Ethernet cable 156 to the Hospital LAN/WAN/WLAN cloud to the authorized viewers, in this case Doctor 162 and Spouse 164. Note that the Doctor may be on a wired Ethernet connection to hospital computer terminal (not illustrated), or on a wireless connection 166 to devices such as a PDA or a video cellular telephone. In a similar manner spouse 164 can access the video while in the hospital over wired or wireless terminals such as on her laptop, or over the Internet 168. In addition Mrs. Jones can access video of Mr. Jones in the Hospital while she is at home by gaining access to the Hospital LAN through the Internet.

In FIG. 12B, Mr. Jones has moved from his patient room 132 to Radiology Room 150 for a procedure such as a CAT scan as illustrated. Other procedures such as an X-Ray, MRI, or the like could also be performed. When Patient 140 exits patient room 132 and enters Radiology Room 150, the camera video is switched from Camera 136 in the patient room to Cameras 152 and/or 154 in the Radiology room. When switching from a room with one camera, such as room 140, to a room with more than one camera, such as room 150, the display on an authorized viewer's monitor screen can also accommodate the change. For example, when the patient is in room 132 with one camera, that camera can be viewed on the monitor. When the patent is in room 150 with two cameras, the system can automatically go to a split screen showing two cameras, or switch user interface to present a selection methodology that allows the user to recognize that there is more than one camera and select between multiple cameras such with radio buttons, sliders, icons or the like.

Note also in FIG. 12B that both the Dr. 162 and spouse 164 have access to the video. This is particularly nice for the spouse 164 because she is denied access to Radiology during the procedure to limit her exposure to X-Rays from the CAT scan of her husband, yet she can see that he is doing well throughout the procedure.

In FIG. 12C Mr. Jones 140 has been taken to surgery for a serious operation. In a similar manner, access to the cameras that were monitoring him in Radiology for Dr. Smith and Mrs. Jones were automatically ‘disconnected’ from viewing by the doctor 162 and spouse 164 when Mr. Jones exits the region of Radiology. When Mr. Jones enters the surgical suite 180, the cameras in the OR, cameras 182 and 184, are enabled for viewing for Dr. Smith 162. Note, however, that the Operating Room has a special status and the system recognizes it as a video location that should be blocked from viewing by family members due to the nature of the procedures that occur in that area. Therefore, any attempts at viewing Mr. Jones by Mrs. Jones while he is in surgery will be automatically “blacked-out” while he is in that area. In a similar manner, not illustrated herein, when Mr. Jones moves to the Recovery room the video feed access for Mrs. Jones is restored and she can view her husband during the recovery process.

It should be noted that any number of doctors, nurses and family members can be given simultaneous but controlled access as is described above. It also is important to note that the transmission of the video can be routed either directly from the camera source, such as by unicast or multicast, or relayed or re-broadcasted by an affiliated server as is described in at least one of the above referenced patent applications.

It is also important to note that access to other important data can be switched in the same manner as the video described above. For example, while the patient is in the CAT scan room, the Doctor can directly access the video produced by the CAT scanner 180. When in an MRI suite, the Doctor can access the MRI data and the like. A second doctor, not illustrated, is a cardiologist, and he can access the EKG feed as is needed. The system is not limiting in any way and the information feeds can be routed from any sources in any room to any authorized recipient who has access to the network, local or remote, wired or wireless.

Although an exemplary embodiment of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the cameras or camera systems can be performed by one or more of the modules or components described herein or in a distributed architecture. For example, all or part of a camera system, or the functionality associated with the system may be included within or co-located with the operator console or the server. Further, the functionality described herein may be performed at various times and in relation to various events, internal or external to the modules or components. Also, the information sent between various modules can be sent between the modules via at least one of a data network, the Internet, a voice network, a wireless network, a wired network and/or via a plurality of protocols. Still further, more components than depicted or described can be utilized by the present invention. For example, a plurality of operator console's and camera's can be used and. Also, a plurality of zones and/or sub-zones may be utilized independently or together with the present invention.

1. A method for monitoring a visual condition of an identified patient located in a health care facility, the method comprising the steps of:
defining an authorized patient zone, the authorized patient zone being located within the health care facility, the authorized patient zone being an area where the identified patient presently is authorized to be located;
placing a video camera in a location to capture a visual image of the patient zone;
capturing with the video camera a time series of captured visual images of the patient zone;
defining a base visual image of the patient zone;
transmitting from the video camera across an internet protocol network to a remote monitoring station the time series of captured visual images;
at the remote monitoring station monitoring the time series of captured visual images;
identifying differences between a captured visual image and the base visual image; and
when differences between a captured visual image and the base visual image meet a threshold criteria, generating an alert.

2. The method of claim 1, including the step of permitting certain changes to occur in the base visual image without generating an alert.

3. The method of claim 2, wherein authorized personnel may enter and leave the zone without generating an alert.

4. The method of claim 1, wherein the remote monitoring station is on at least one of:
a local area network;
a wide area network;
a data network;
an Internet Protocol network;
a wireless network; and
a wired network.

5. The method of claim 1, further including a sub-zone within the zone, with the patient being located within the sub-zone.

6. The method of claim 5, wherein the sub-zone is defined by a color on the patient clothing.

7. The method of claim 5, wherein the sub-zone is defined by a pattern on the patient clothing.

8. The method of claim 5, wherein the sub-zone is defined by facial recognition of the patient.

9. The method of claim 3, wherein the authorized personnel are identified by an identifying mechanism worn on their person.

10. The method of claim 9, wherein the identifying mechanism is an RIFD tag worn by the authorized personnel.

11. The method of claim 9, wherein the identifying mechanism is a color worn on the clothing of the authorized personnel.

12. The method of claim 9, wherein the authorized personnel are identified by facial recognition.

13. The method of claim 2, wherein the presence of certain personnel other than a patient in the zone is not a change in the base visual image.

14. The method of claim 13, wherein certain movements of personnel into and out of the zone are not a change in the base visual image.

15. The method of claim 1, further including the steps of collecting vital sign data in the zone and monitoring the vital sign data.

16. The method of claim 15 comprising generating an alert when defined changes in the vital sign data occur.

17. The method of claim 1, wherein the alert is an audible alert.

18. The method of claim 1, wherein the alert is a visual alert.

19. A method for monitoring the visual condition of a certain patient located in a health care facility, the method comprising:
defining a patient zone, the patient zone being located within the health care facility, the patient zone including an area where the certain patient presently is located;
defining a sub-zone within the patient zone, wherein the sub-zone is defined by at least one of:
a color on a patient's clothing;
a pattern on the patient's clothing; and
a facial recognition of the patient;
placing a video camera in a location to capture a visual image of the patient zone;
defining a base visual image of the patient zone;
capturing with the video camera a captured visual image of the patient zone;
transmitting from the video camera across an internet protocol network to a remote monitoring station the captured visual image;
at the remote monitoring station monitoring the captured visual image; and
identifying differences between a captured visual image and the base visual image.

20. A method for monitoring the visual condition of a certain patient as set forth in claim 19 and further comprising:
when differences between a captured visual image and the base visual image are due to the presence within the patient zone of certain personnel other than the identified patient.
